(19) United States
(12) Patent Application Publication
(10) Pub. No.: US 2019/0128356 A1
(43) Pub. Date: May 2, 2019

(54) EXTENSION SPRING WITH SACRIFICIAL ANODE

(71) Applicant: S3 ENTERPRISES INC., Regina, Saskatchewan (CA)

(72) Inventor: Edward Robert SONNTAG, Cochrane, Alberta (CA)

(21) Appl. No.: 16/096,060

(22) PCT Filed: Apr. 25, 2016
(86) PCT No.: PCT/CA2016/000126

§ 371 Date: Oct. 24, 2018

(51) Int. Cl. F16F 1/12; C23F 13/10; C23F 13/18; F16F 1/06

(52) U.S. Cl. CPC F16F 1/125; C23F 13/10; C23F 13/18; F16F 2238/026; F16F 2230/0023; F16F 2224/0208; F16F 1/06

(57) ABSTRACT

An extension spring assembly including a helical extension spring having a plurality of coils and at least a sacrificial anode mounted to the extension spring such that the sacrificial anode is in direct electrically conductive contact with the extension spring.

This application is a U.S. national stage filing of International Application Number PCT/CA2016/000126 (International Publication Number WO 2017/185157), filed on Apr. 25, 2016 and entitled Extension Spring with Sacrificial Anode, the entire contents of which are hereby incorporated by reference.

### FIELD

The present invention relates extension springs, and more particularly, to an extension spring having a sacrificial anode for corrosion protection.

### BACKGROUND

In numerous applications corrosion of extension springs is a concern, since spring wire is highly susceptible to breakage even at the presence of only small amounts of surface corrosion.

In particular, in extension springs using end mounts wound into end portions of the extension springs for mounting the same to a machine, corrosion of the extension springs in proximity to the contact area between the extension springs and the end mounts frequently results in breakage of the extension springs, even if the end mounts and the extension springs have been coated for corrosion protection.

In many situations when extension springs are mounted into machinery, it is very costly and time consuming to replace the same, or to remove them for repair/refurbishment, including recoating. Corrosion in extension springs can occur under the paint or coating layers. Thus, the corrosion is not readily visible and may go unnoticed. Extension springs that experience corrosion often fail suddenly under load, which can result in substantial damage to the machine and pose a substantial safety hazard to people in the immediate area.

To improve the corrosion protection, extension springs have been coated with a variety of coatings and sealants, including primer coats that utilize high levels of zinc or other sacrificial materials. Unfortunately, it is not easy to detect, for example, through visual inspections during maintenance of the machine, if the protective coating still contains sufficient amounts of the sacrificial materials. Furthermore, replacement/refurbishment of the protective coating requires removal of the extension spring from the machine.

It may be desirable to provide an extension spring having sacrificial anode protection that enables easy inspection of the sacrificial material with the extension spring remaining mounted to a machine.

It also may be desirable to provide an extension spring having sacrificial anode protection that enables easy replacement of the sacrificial material with the extension spring remaining mounted to a machine.

It also may be desirable to provide an extension spring having sacrificial anode protection that enables easy tightening of the sacrificial material to the extension spring with the extension spring remaining mounted to a machine.

### SUMMARY

Accordingly, one object of the present disclosure is to provide an extension spring having sacrificial anode protection that enables easy inspection of the sacrificial material with the extension spring remaining mounted to a machine.

Another object of the present disclosure is to provide an extension spring having sacrificial anode protection that enables easy replacement of the sacrificial material with the extension spring remaining mounted to a machine.

Another object of the present disclosure is to provide an extension spring having sacrificial anode protection that enables easy tightening of the sacrificial material to the extension spring with the extension spring remaining mounted to a machine.

According to one aspect of the present disclosure, there is provided an extension spring assembly. The extension spring assembly comprises a helical extension spring having a plurality of coils and at least a sacrificial anode mounted to the extension spring such that the sacrificial anode is in direct electrically conductive contact with the extension spring.

According to one aspect of the present disclosure, there is provided an extension spring assembly. The extension spring assembly comprises a helical extension spring having a plurality of coils. Two end mounts having grooves are wound into respective coils of end portions of the extension spring. A sacrificial anode is mounted to at least one of the end portions of the extension spring such that the sacrificial anode is in direct electrically conductive contact with the extension spring.

According to one aspect of the present disclosure, there is provided an extension spring assembly. The extension spring assembly comprises a helical extension spring having a plurality of coils. Two end mounts having grooves are wound into respective coils of end portions of the extension spring. A sacrificial anode is mounted to at least one of the end portions of the extension spring such that the sacrificial anode is in direct electrically conductive contact with the extension spring. The sacrificial anode comprises a split ring structure having two ring elements clamped to the extension spring where the coils of the extension spring are engaged with the end mount. A clamping mechanism comprises two screw bolts accommodated in respective bores disposed in the two ring elements opposite each other.

An advantage of the present disclosure is that it provides an extension spring having sacrificial anode protection that enables easy inspection of the sacrificial material with the extension spring remaining mounted to a machine.

A further advantage of the present disclosure is that it provides an extension spring having sacrificial anode protection that enables easy replacement of the sacrificial material with the extension spring remaining mounted to a machine.

A further advantage of the present disclosure is that it provides an extension spring having sacrificial anode protection that enables easy tightening of the sacrificial material to the extension spring with the extension spring remaining mounted to a machine.

### BRIEF DESCRIPTION OF THE DRAWINGS

An embodiment of the present invention is described below with reference to the accompanying drawings, in which:

FIGS. 1a and 1b are simplified block diagrams illustrating in side views an extension spring assembly according to an embodiment of the invention;

FIG. 1c is a simplified block diagram illustrating in a cross sectional view an end portion of the extension spring assembly according to an embodiment of the invention;

FIG. 1d is a simplified block diagram illustrating in a front view the extension spring assembly according to an embodiment of the invention;

FIG. 1e is a simplified block diagram illustrating in a cross sectional view an inside surface of a sacrificial anode ring element of the extension spring assembly according to an embodiment of the invention;

FIG. 1f is a simplified block diagram illustrating in a detailed view contact between the inside surface of the sacrificial anode ring element with a coil of the extension spring of the extension spring assembly according to an embodiment of the invention;

FIGS. 2a to 2c are simplified block diagrams illustrating in a detailed views contact between alternative inside surfaces of the sacrificial anode ring element with a coil of the extension spring of the extension spring assembly according to an embodiment of the invention;

FIG. 3 is a simplified block diagram illustrating in a front view an extension spring assembly according to another embodiment of the invention;

FIG. 4a is a simplified block diagram illustrating in a front view an extension spring assembly according to another embodiment of the invention;

FIG. 4b is a simplified block diagram illustrating in a cross sectional view an a sacrificial anode ring element of the extension spring assembly according to an embodiment of the invention illustrated in FIG. 4a;

FIGS. 5 and 6 are simplified block diagrams illustrating in front views an extension spring assembly according to other embodiments of the invention;

FIGS. 7a to 7c are simplified block diagrams illustrating in a front view, an inside view and an outside view, respectively, a sacrificial anode ring element of the extension spring assembly according to another embodiment of the invention;

FIGS. 7d and 7e are simplified block diagrams illustrating in a front view and an outside view, respectively, a sacrificial anode ring element of the extension spring assembly according to another embodiment of the invention; and,

FIG. 7f is a simplified block diagram illustrating in a front view a sacrificial anode ring element of the extension spring assembly according to another embodiment of the invention.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

While the description of the embodiments hereinbelow is with reference to an extension spring having end mounts, it will become evident to those skilled in the art that the embodiments of the invention are not limited thereto, but that some embodiments of the sacrificial anode protection may also be employed for protecting extension springs having loop or hook ends for mounting the same to a machine.

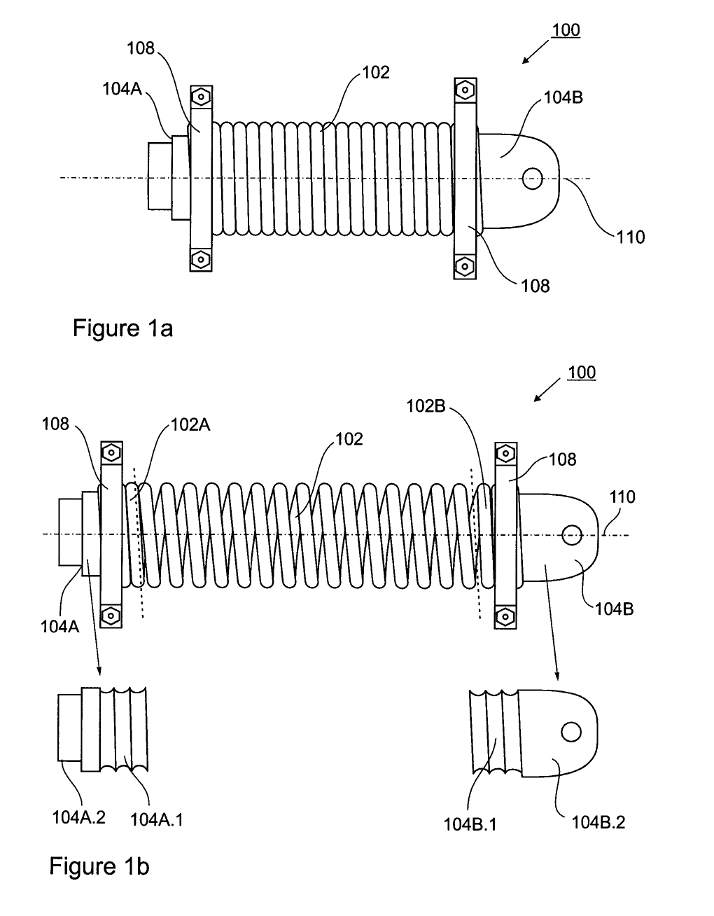

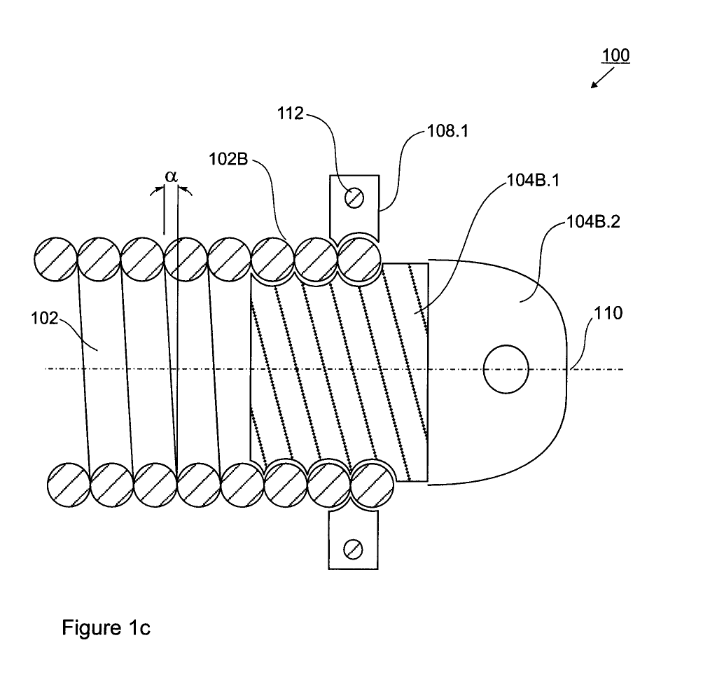

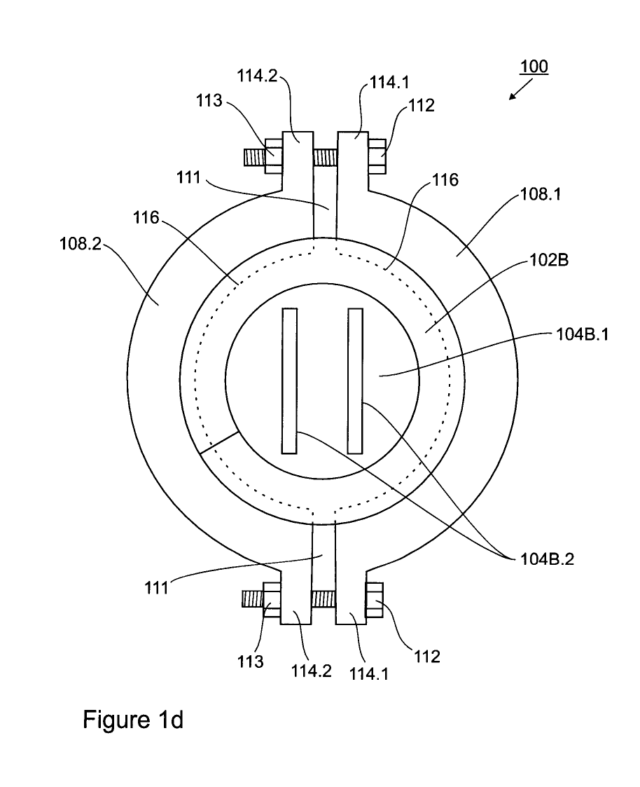

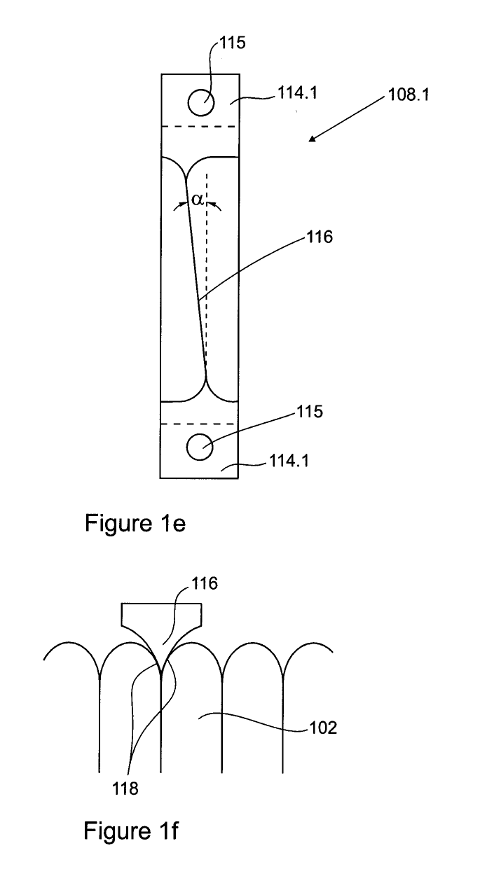

Referring to FIGS. 1a to 1f, an extension spring assembly 100 having a sacrificial anode for corrosion protection according to an embodiment of the invention is provided. The extension spring assembly 100 comprises helical extension spring 102 and end mounts 104A and 104B. The helical extension spring 102 has a plurality of coils disposed along longitudinal axis 110 between a first end portion 102A and a second end portion 102B. The end mounts 104A, 104B each comprise a mounting portion 104A.2, 104B.2 and a coil interacting portion 104A.1, 104B.1 having grooves disposed thereon in a screw-type fashion which are wound into respective coils of the end portions 102A, 102B of the extension spring 102, respectively. With the coils of the two end portions 102A and 102B being substantially fixed with respect to each other by interacting with the respective coil interacting portions 104A.1, 104B.1 of the end mounts 104A, 104B, the extension of the spring is provided by the plurality of coils disposed therebetween, as illustrated by the dashed lines in FIG. 1b.

Sacrificial anodes 108 can be mounted to the end portions 102A and 102B of the extension spring 102 such that the sacrificial anodes 108 are in direct electrically conductive contact with the extension spring 102. The sacrificial anodes 108 are made of a metal such as, for example, zinc, aluminum, magnesium, or alloys thereof, i.e. a metal that is “anodic” or “less noble” compared to the material of the extension spring 102 such as, for example, chrome/silica steel alloy.

Further in one case, the sacrificial anodes comprise a split ring structure with two ring elements 108.1 and 108.2 which are clamped to the extension spring 102 having a gap 111 therebetween, as is illustrated in FIGS. 1c and 1d. The two ring elements 108.1 and 108.2 each comprise respective flanges 114.1 and 114.2 having bores 115 disposed therein, as illustrated in FIGS. 1d and 1e. The two ring elements 108.1 and 108.2 are then clamped to the extension spring 102 using screw bolts 112 accommodated in the respective bores 115 and screw nuts 113. The two ring elements 108.1 and 108.2 are easily placed onto the extension spring 102. The clamping mechanism comprising two screw bolts 112 and respective screw nuts 113 is easily tightened while the extension spring assembly 100 remains mounted to a machine for replacement, as well as for re-tightening after some of the anode material has been consumed. The sacrificial anodes 108 are easily inspected, visually to detect the amount of sacrificial material present as well as manually to see if the sacrificial anodes 108 are still tightly mounted to the extension spring 102. Optionally, the clamping mechanism comprises wing nuts enabling re-tightening of the same without tools.

Further in one case, each ring element 108.1 and 108.2 comprises a ridge 116 disposed between two adjacent coils of the extension spring 102 such that a surface portion thereof is in direct contact with a respective surface portion of the coils of the extension spring 102, as illustrated in FIG. 1f. The flanks of the ridge 116 may be curved corresponding to the curvature of the respective surface portion of the coils of the extension spring 102 to increase the contact area between the sacrificial anode material and the extension spring 102. Alternatively, the flanks are flat to simplify manufacture thereof. Disposal of the ridge 116 between two adjacent coils of the extension spring 102 enables securing of the sacrificial anodes 108 in longitudinal direction 110, for example, when the extension spring 102 is exposed to substantial vibrations. To ensure proper contact and to facilitate mounting of the sacrificial anodes 108, the ridge 116 is, preferably, disposed at angle α corresponding to the pitch a of the coils of the extension spring 102, as illustrated in FIGS. 1c and 1e.

The sacrificial anodes 108 can be placed at a location where the coils of the extension spring 102 are wound onto the respective grooves of the end mounts 104A, 104B.

The ring elements 108.1 and 108.2 including flanges 114.1 and 114.2 are made of a metal such as, for example, zinc, aluminum, magnesium, or alloys thereof using a conventional metal molding process. The screw bolts 112 and the screw nuts 113 are, for example, off-the-shelf hardware items made of a metal or plastic material. The size of the ring elements 108.1 and 108.2 is variable in a wide range to accommodate extension springs 102 having various sizes with the cross sectional area of the ring elements being sufficient for the ring elements to be strong enough for clamping and having sufficient sacrificial material for consumption while also being sized to allow assembly/disassembly with the extension spring being mounted to a machine.

Optionally, the extension spring assembly 100 comprises only one sacrificial anode 108, for example, when the extension spring assembly 100 is exposed to a less corrosive environment such as a protective enclosure.

The extension spring assembly 100 can be provided with a protective coating, for example, as disclosed in United States Patent Application Publication 2015/0137438, the entire contents of which are hereby incorporated by reference. The coating processes are easily adapted by masking the outside surface portions of the extension spring 102 where the sacrificial anodes will be placed thereon prior coating using, for example, masking tape or strips of metal foil placed on the respective outside surface portions.

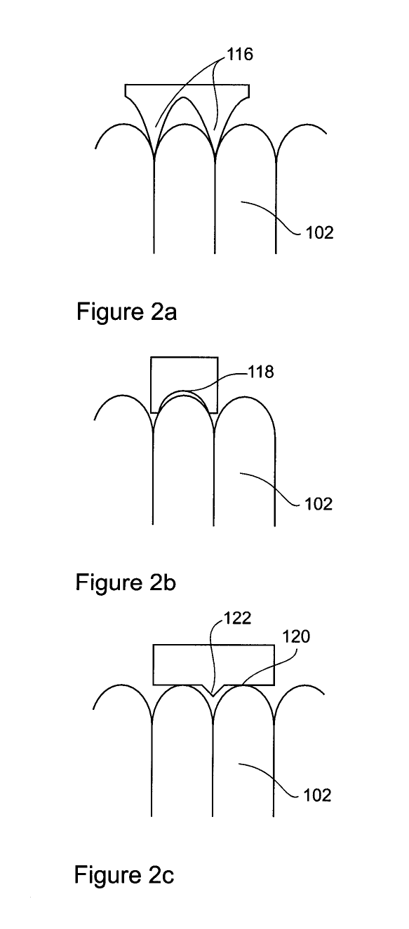

Alternatively, the ring elements 108.1 and 108.2 may comprise more than one ridge 116, as illustrated in FIG. 2a. Further alternatively, the ring elements 108.1 and 108.2 may comprise a groove 118, instead of the ridge 116, for being placed onto an outside surface portion of a coil of the extension spring 102, as illustrated in FIG. 2b, which can be preferable when mounted to extension springs having hook or loop ends. Further alternatively, the ring elements 108.1 and 108.2 may comprise a substantially flat surface 120, as illustrated in FIG. 2c. Ridge 122 can be disposed on the flat surface 120 for securing the sacrificial anode in longitudinal direction 110.

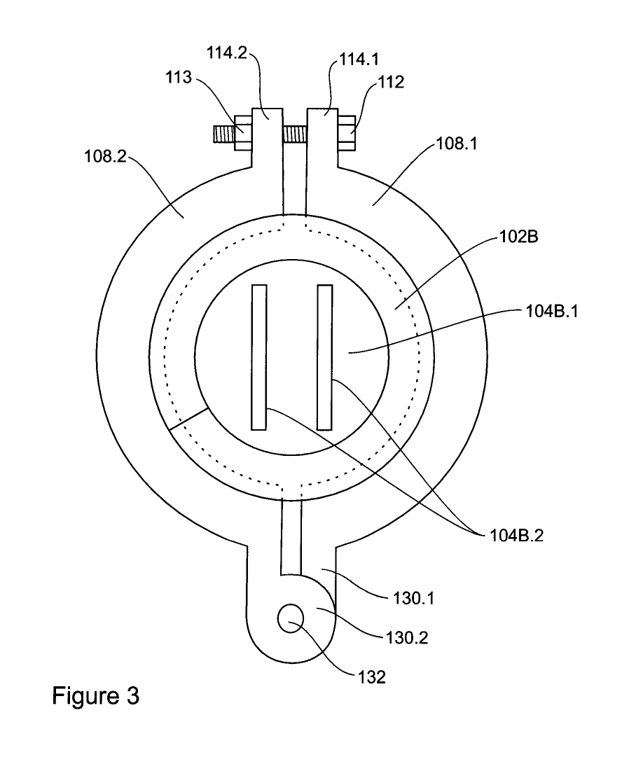

Referring to FIG. 3, the ring elements 108.1 and 108.2 may be pivotally movable connected via hinge elements 130.1, 130.2 and pivot 132. The ring elements 108.1 and 108.2 are then clamped to the extension spring 102 using screw bolt 112 and screw nut 113 placed opposite the hinge, which also enables re-tightening.

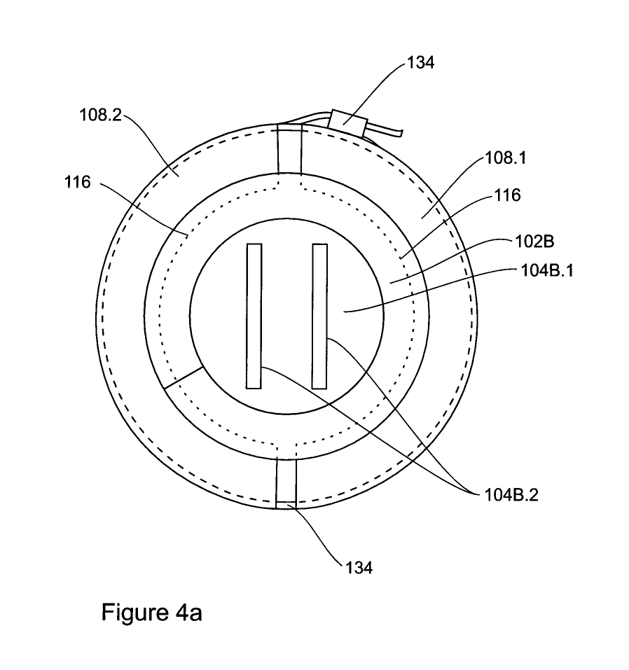

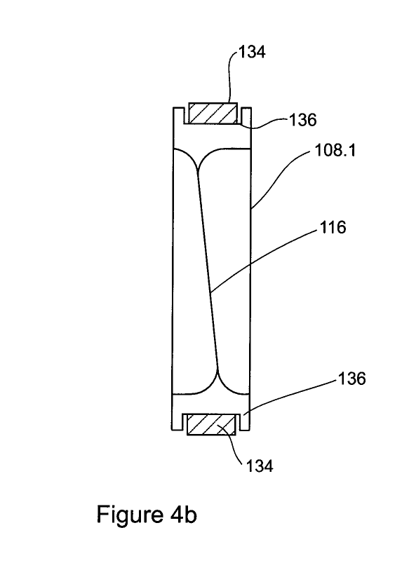

Referring to FIGS. 4a and 4b, the ring elements 108.1 and 108.2 may be clamped to the extension spring 102 using a cable tie 134 or a hose clamp disposed in a respective groove 136 in the outside surface of the ring elements 108.1 and 108.2. As above, the cable tie 134 and the hose clamp also allow re-tightening.

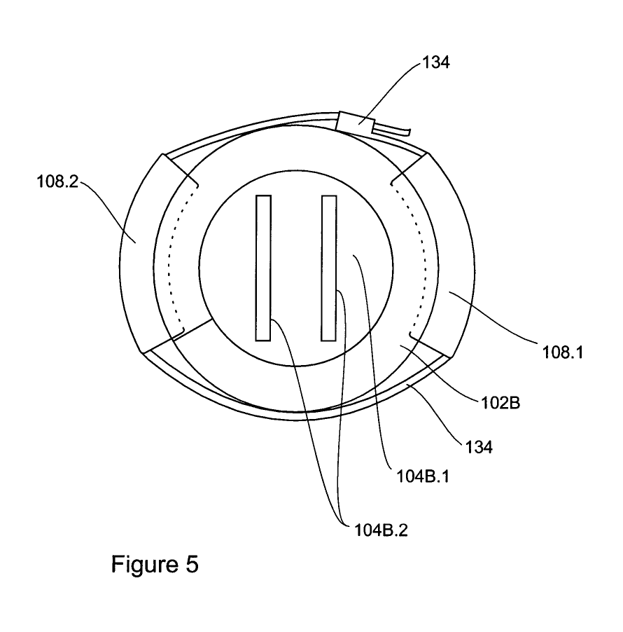

Referring to FIG. 5, the ring elements may be provided as shorter blocks 108.1 and 108.2 clamped to the extension spring 102 using a cable tie 134 or a hose clamp, for example, in situations where there is not sufficient space for a ring structure as illustrated in FIG. 4a. Optionally, only one block 108.1 is utilized.

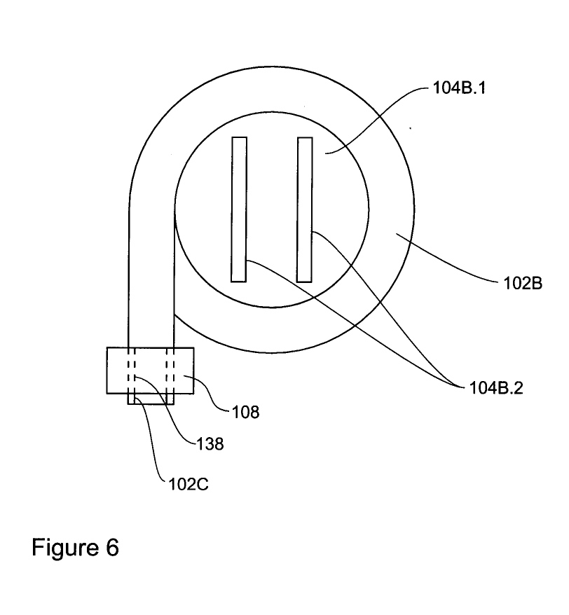

Referring to FIG. 6, the sacrificial anode 108 may be mounted to an end portion 102C of the extension spring 102. The end portion 102C of the extension spring 102 is bent outwardly and comprises a screw thread disposed thereon which is mated with a respective screw thread disposed in the sacrificial anode 108.

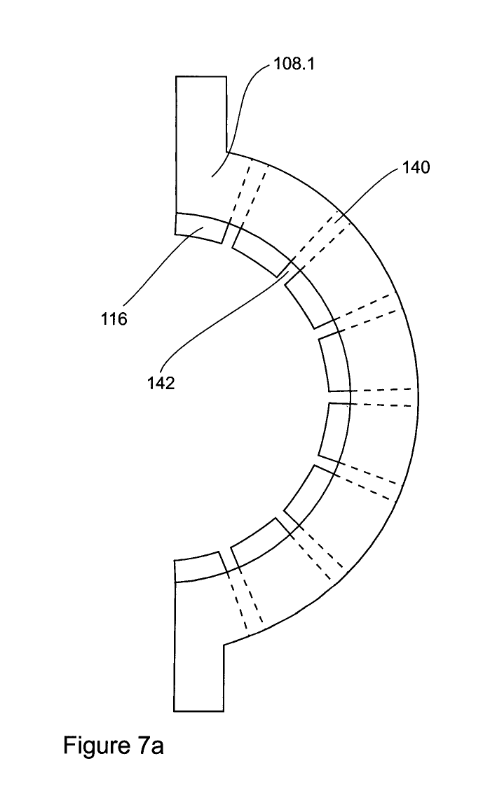

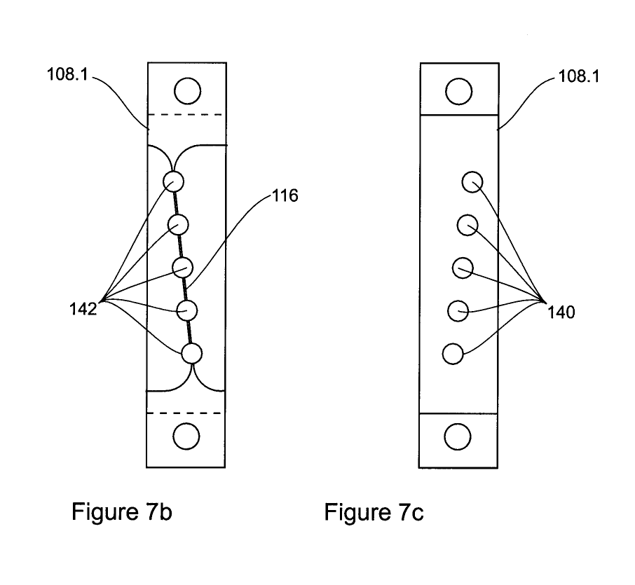

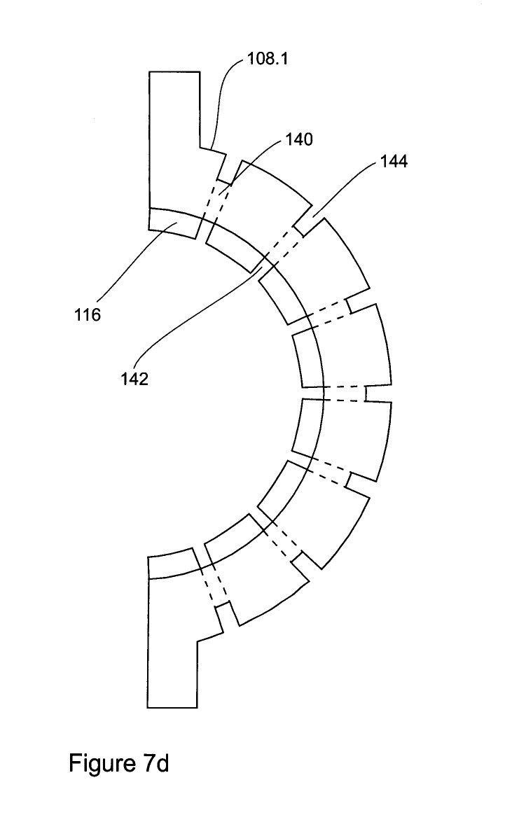

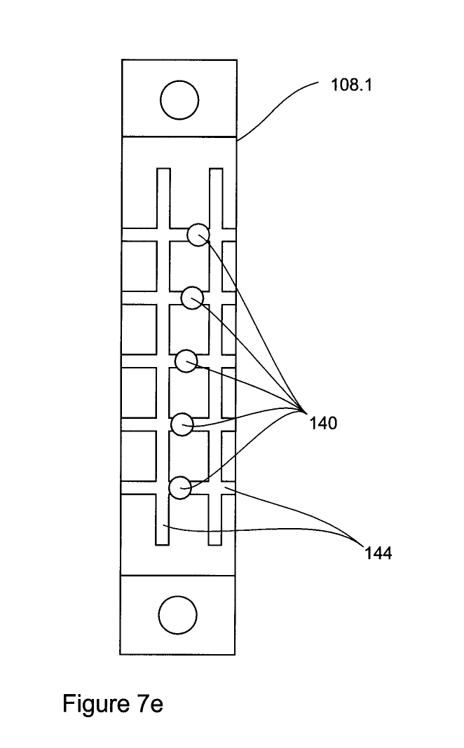

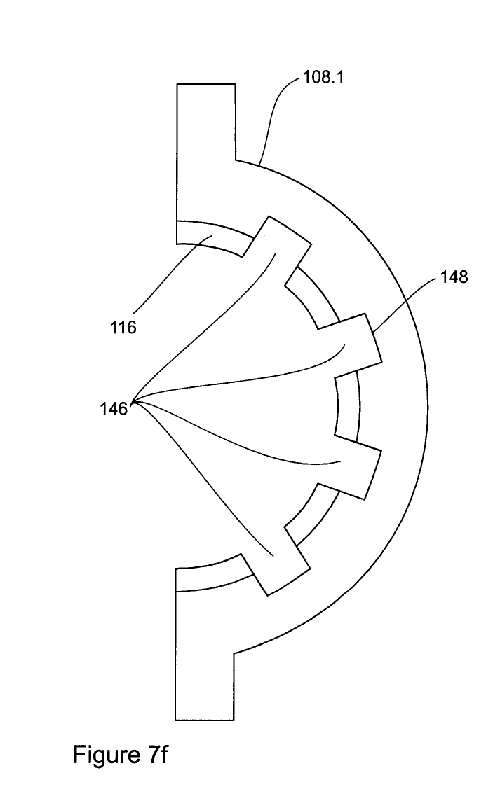

Optionally, conduits are disposed in the sacrificial anode 108 in order to trap electrolyte—typically water with salt and other minerals dissolved therein—from the environment surrounding the sacrificial anode 108, and to provide the same proximate the contact area between the sacrificial anode 108 and the extension spring 102. For example, bores 140 are disposed in the ring elements of the sacrificial anode 108 providing the electrolyte therethrough from the outside of the ring elements to respective cut-outs 142 in the ridge 116, as illustrated in FIGS. 7a to 7c. Further optionally, grooves 144 are disposed—for example, in a mesh-like pattern—in the outside surface of the ring elements and connected to the bores 140, as illustrated in FIGS. 7d and 7e, to increase the amount of trapped electrolyte and provide the same to the bores 140. Alternatively, cut-outs 146 are disposed in the ring element such that surface 148 thereof is placed outside the extension spring 102, as illustrated in FIG. 7f.

The present invention has been described herein with regard to certain embodiments. However, it will be obvious to persons skilled in the art that a number of variations and modifications can be made without departing from the scope of the invention as described herein.

The embodiments of the invention in which an exclusive property or privilege is claimed are defined as follows:

1. An extension spring assembly comprising:
a helical extension spring having a plurality of coils; and,
at least a sacrificial anode mounted to the extension spring such that the sacrificial anode is in direct electrically conductive contact with the extension spring.

2. The extension spring assembly according to claim 1 wherein the at least a sacrificial anode is mounted to at least one of a first end portion and a second end portion of the extension spring.

3. The extension spring assembly according to claim 2 wherein the at least a sacrificial anode is clamped to the extension spring.

4. The extension spring assembly according to claim 3 wherein the at least a sacrificial anode comprises a split ring structure.

5. The extension spring assembly according to claim 4 wherein the at least a sacrificial anode comprises two ring elements and a clamping mechanism.

6. The extension spring assembly according to claim 5 wherein the clamping mechanism comprises at least a screw bolt accommodated in respective bores disposed in the two ring elements.

7. The extension spring assembly according to claim 6 wherein the clamping mechanism comprises a hinge pivotally movable connecting the two ring elements and a screw bolt accommodated in respective bores disposed in the two ring elements substantially opposite the hinge.

8. The extension spring assembly according to claim 5 wherein each ring element comprises at least a ridge disposed between adjacent coils of the extension spring.

9. The extension spring assembly according to claim 8 wherein at least a ridge is disposed at an angle corresponding to a pitch of the extension spring.

10. The extension spring assembly according to claim 5 wherein each ring element comprises at least a groove accommodating a portion of a coil of the extension spring therein.

11. The extension spring assembly according to claim 2 comprising two end mounts having grooves wound into respective coils of the end portions of the extension spring.

12. The extension spring assembly according to claim 11 wherein the at least a sacrificial anode is placed where the coils of the extension spring are wound onto the respective grooves.

13. An extension spring assembly comprising:
a helical extension spring having a plurality of coils;
two end mounts having grooves wound into respective coils of end portions of the extension spring; and,
a sacrificial anode mounted to at least one of the end portions of the extension spring such that the sacrificial anode is in direct electrically conductive contact with the extension spring.

14. The extension spring assembly according to claim 13 wherein the sacrificial anode is clamped to the extension spring where the coils of the extension spring are engaged with the end mount.

15. The extension spring assembly according to claim 14 wherein the sacrificial anode comprises a split ring structure.

16. The extension spring assembly according to claim 15 wherein the sacrificial anode comprises two ring elements and a clamping mechanism.

17. The extension spring assembly according to claim 16 wherein the clamping mechanism comprises at least a screw bolt accommodated in respective bores disposed in the two ring elements.

18. The extension spring assembly according to claim 17 wherein the clamping mechanism comprises a hinge pivotally movable connecting the two ring elements and a screw bolt accommodated in respective bores disposed in the two ring elements substantially opposite the hinge.

19. The extension spring assembly according to claim 16 wherein each ring element comprises at least a ridge disposed between adjacent coils of the extension spring.

20. The extension spring assembly according to claim 16 wherein each ring element comprises at least a groove accommodating a portion of a coil of the extension spring therein.
